(19) United States
(12) Patent Application Publication
(10) Pub. No.: US 2017/0312895 A1
(43) Pub. Date: Nov. 2, 2017

(54) FLUID-POWERED TORQUE WRENCH WITH FLUID PUMP CONTROLS

(71) Applicant: Actuant Corporation, Menomonee Falls, WI (US)

(72) Inventors: Tyler Jeffrey Johnson, Ripon, WI (US); Niklas Linn Olson, Antigo, WI (US); Luke Wesley Waddingham, Milwaukee, WI (US)

(21) Appl. No.: 15/584,819

(22) Filed: May 2, 2017

Related U.S. Application Data
(60) Provisional application No. 62/330,617, filed on May 2, 2016.

(51) Int. Cl. B25B 21/00; B25B 23/16; B23Q 5/58

(52) U.S. Cl. CPC B25B 21/005; B23Q 5/58; B25B 23/16

(57) ABSTRACT

A fluid-operated, reciprocating piston-style torque wrench and a method of operating the same. The wrench may have pump controls coupled to the torque wrench. The pump controls may be connected to a handle assembly that is coupled to the torque wrench. The handle assembly may include sensors to require two hand operation of the pump controls.

### RELATED APPLICATIONS

The present application claims priority to co-pending U.S. Provisional Patent Application No. 62/330,617, filed May 2, 2016, and is related to U.S. Design Patent Application No. 29/563,103, filed May 2, 2016, the entire contents of both of which are hereby incorporated by reference.

### FIELD

The present invention relates to a fluid-powered torque wrench and, more particularly, to such a wrench in which the controls require two-hand operation.

### SUMMARY

Fluid-powered wrenches designed for the transmission of rotational power to threaded fasteners are widely used tools in industry. There are a variety of different types of power wrenches, but one typical wrench design consists of a fluid-driven, reciprocating piston driving a socket. These reciprocating piston style torque wrenches are commonly used in flange bolting operations due to their compact nature.

With reciprocating piston-style torque wrenches, a fluid pump is coupled to the wrench via a hose to drive the piston. The pump is typically actuated via controls located on the pump or coupled to the pump via a pendant.

In operation, it is common to use two technicians to operate this style of wrench. One technician positions the wrench on the nut to be tightened. Once in position and clear of pinch points, that technician communicates to the other technician to operate the pump to actuate the wrench. Miscommunication may result undesirable operations, especially for the first technician.

Thus, a need may exist to allow a single technician to operate a reciprocating piston-style fluid-operated torque wrench. Some much larger electronic, motor-driven torque wrenches (sometimes called torque multipliers) allow for this, but such operation is not known for the much more compact piston-style fluid-operated torque wrenches.

A further need may exist to have such a reciprocating piston-style fluid-operated torque wrench that can also remain compact.

In one independent aspect, a reciprocating piston-style torque wrench having pump controls coupled to the torque wrench may be provided. In some embodiments, the pump controls are selectively coupled to the torque wrench to allow the wrench to fit into tight areas while keeping the controls adjacent the wrench.

In another independent aspect, a handle with pump controls may be coupled to a fluid operated, reciprocating piston style torque wrench. In some embodiments, the handle is selectively coupled to the wrench to allow the wrench to fit into tight areas.

In yet another independent aspect, a handle with pump controls may be coupled to the reciprocating piston-style torque wrench, wherein the handle requires two hand operation.

In one particular independent embodiment, a fluid-operated, reciprocating piston-style torque wrench having fluid pump controls selectively coupled to the torque wrench may be provided. The wrench may further include a handle housing the pump controls, the handle being selectively coupled to the torque wrench. The handle may include a first grasping location and a second grasping location, wherein the wrench cannot be operated unless an operator's hands are on both grasping locations. The handle may further include a first actuator located adjacent the first grasping location and a second actuator located adjacent the second grasping location and wherein the wrench cannot operate unless both actuators are actuated.

In a further independent embodiment, a control assembly for a fluid-operated, reciprocating piston-style torque wrench may be provided. The wrench may include a housing, and a reciprocating drive mechanism supported by the housing, the drive mechanism being selectively-driven by a fluid pump and operable to drive an output member. The assembly may generally include a body connectable to the housing; a first handle and a second handle connected to the body; a first sensor operable to sense an operator's first hand on the first handle; and a second sensor operable to sense the operator's second hand on the second handle. Operation of the pump may require sensing the operator's first hand on the first handle while sensing the operator's second hand on the second handle.

In another independent embodiment, a torque wrench may generally include a housing; a reciprocating drive mechanism supported by the housing, the drive mechanism being selectively-driven by a fluid pump and operable to drive an output member; and a control assembly. The control assembly may include a body connected to the housing, a first handle and a second handle connected to the body, and pump controls operable to control the pump to drive the drive mechanism and thereby the output member. The pump controls may include a first pump control supported proximate the first handle, the first pump control being operable by a digit of a first hand of an operator gripping the first handle, and a second pump control supported proximate the second handle, the second pump control being operable by a digit of a second hand of the operator on the second handle. The pump may be operable upon operation of the first pump control and the second pump control

In yet another independent embodiment, a method of operating a fluid-operated, reciprocating piston-style torque wrench may be provided. The wrench may include a housing, and a reciprocating drive mechanism supported by the housing and operable to drive an output member. The method may generally include providing a control assembly connected to the housing, the control assembly including a body connected to the housing and a first handle and a second handle connected to the body; positioning the output member relative to a fastener to be adjusted; and after positioning, operating a fluid pump to drive the drive mechanism and thereby the output member to adjust the fastener, operating including sensing the operator's first hand on the first handle while sensing the operator's second hand on the second handle.

Independent features and independent advantages of the invention may become apparent to those skilled in the art upon review of the detailed description, claims and drawings.

### BRIEF DESCRIPTION OF DRAWINGS

FIG. 1 is a perspective view of one independent embodiment of a reciprocating piston fluid-operated torque wrench having integrated controls.

FIG. 2 is a top view of the wrench and control assembly of FIG. 1.

FIG. 3 is a first perspective view of the control assembly of FIG. 1.

FIG. 4 is a second perspective view of the control assembly of FIG. 1.

FIG. 5 is a top view of the control assembly of FIG. 1.

FIG. 6 is a front view of the control assembly of FIG. 1.

FIG. 7 is a side view of the control assembly of FIG. 1.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

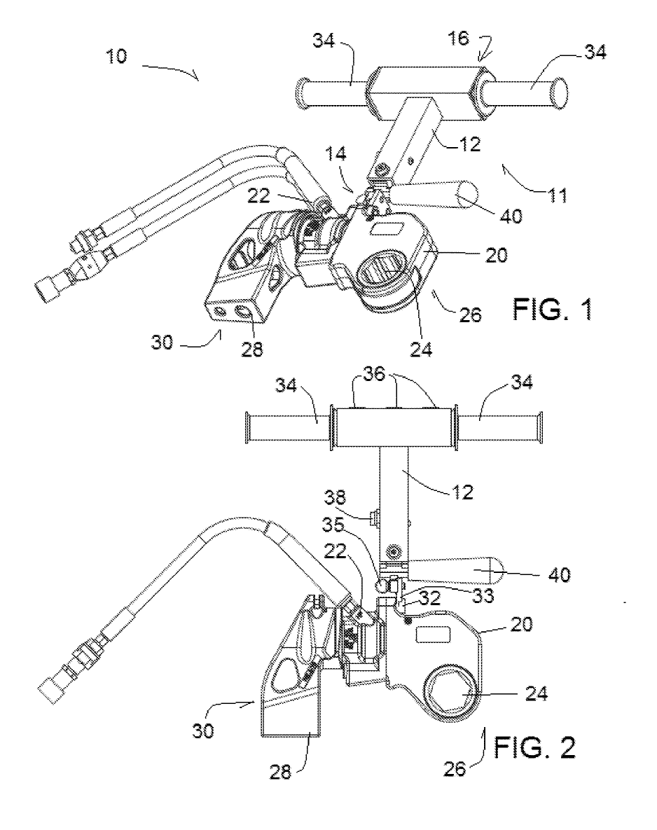

Referring now to FIGS. 1 and 2, a wrench with selectively integrated controls 10 is provided. The wrench with selectively integrated controls 10 includes a control assembly 11 coupled to a reciprocating piston style torque wrench 20.

The control assembly 11 includes a body 12 having a first end 14 selectively coupled to the wrench 20 and a second end 16 supporting controls 36 for a remotely-located fluid pump (not shown), such as a hydraulic pump.

The torque wrench 20 can be a conventional compact, relatively flat wrench, such as that described in U.S. Pat. Nos. 4,825,730 and 4,982,626, which are hereby incorporated by reference with respect to the construction and operation of a reciprocating piston-style, fluid-operated torque wrench.

As illustrated, the wrench 20 has a housing containing the reciprocating piston drive mechanism (not shown). The housing includes fluid inputs and outputs 22 which fluidly communicate with a remotely-located fluid pump to selectively drive the piston drive mechanism. The wrench 20 further includes a socket 24 on a first end 26 of the tool 20 and a reaction arm 28 on the second end 30 of the tool 20. Although the socket 24 is illustrated as a hexagonal opening, in other embodiments (not shown), the socket can be a driver, such as a square projecting socket driver. However, in low clearance operations, a hexagonal opening is typically utilized.

In conventional operation of the wrench 20, the socket 24 is placed on a nut (not shown) by a first operator with the reaction arm 28 in engagement with a portion of a flange or an adjacent nut (also not shown). Once the wrench 20 is securely in position and the first operator is clear, the second operator actuates the pump remotely to provide fluid to the wrench 20, which drives the drive mechanism, and turns the socket 24 while the reaction arm 28 pushes against the reaction surface. Upon completion of the torque application, the second operator turns the pump off, and the first operator moves the wrench 20 to another nut. This process is then repeated for all nuts on a flange.

As noted above, this can be a cumbersome operation with either two operators or with one operator switching from wrench manipulation to pump control manipulation. Thus, a pump control coupled to the wrench 20 may be desirable to allow single person operation without the need to switch between manipulation of the wrench 20 and the pump—or without reliance upon another person. The control assembly 11 provides such operation.

As shown in FIGS. 1 and 2, a control assembly 11 is coupled to the wrench 20. The control assembly 11 is coupled to wrench 20 with a fastener 35 allowing the control assembly 11 to be selectively coupled (and decoupled) to the wrench 20. In the illustrated embodiment, threaded fasteners are used to connect the first end 14 of the body 12 to the wrench 20. In other embodiments (not shown), the control assembly 11 can be permanently coupled to the wrench 20.

In the illustrated embodiment, the control assembly 11 is coupled to the wrench 20 via a first fastener 32, a mounting bracket 33, and second fastener 35. The first fastener 32 connects the mounting bracket 33 to the wrench 20. The second fastener 35 connects the first end of the body 12 to the mounting bracket 33. As illustrated, the second fastener 35 includes a thumb screw allowing for easy user manipulation to selectively remove the control assembly 11 from the wrench 20. In some embodiments, mounting brackets may be sized differently for different wrenches while the interconnection between the control assembly 11 and the bracket 33 is standardized.

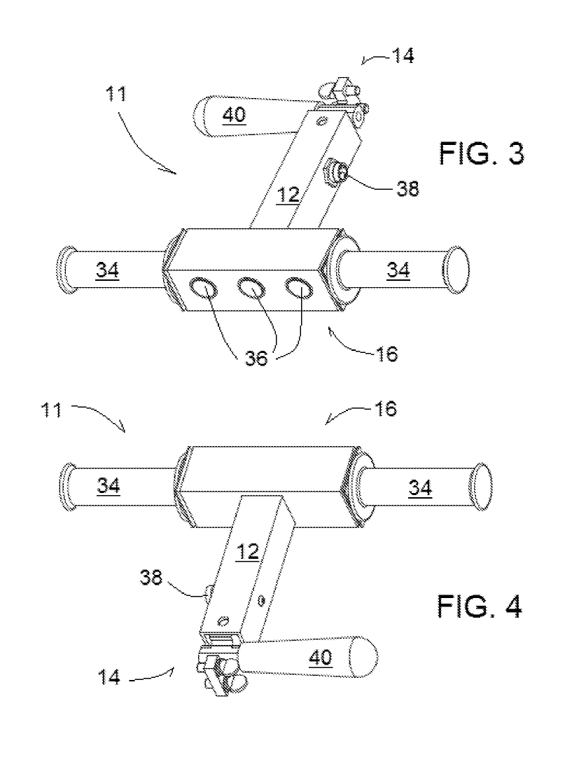

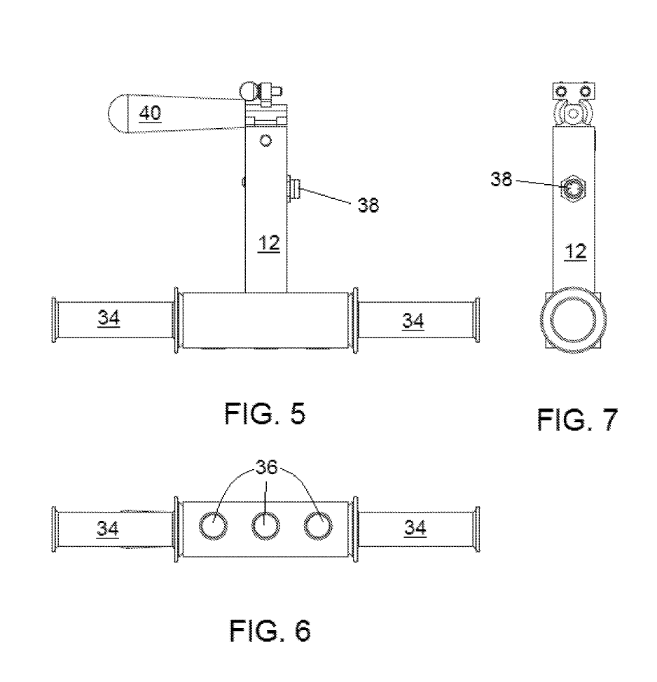

FIGS. 3-7 illustrate the control assembly 11 of FIGS. 1 and 2 decoupled from the wrench 20. As shown, the body 12 is generally T-shaped with the bottom of the “T” terminating at the first end 14 and the top of the “T” at the second end 16. As shown, handles 34 can be coupled to the top of the T-shaped body 12 to form gripping surfaces during actuation of the wrench 20.

As best illustrated in FIGS. 3 and 6, the pump controls 36 can be positioned between the two handles 34. The pump controls 36 can include one or more actuators or control members. As shown, the illustrated embodiment includes three buttons 36—one button can be an “on/off” switch to turn the pump on and off, and the other two buttons can be used to control the flow of fluid to the wrench 20. Each button 36 is operable by a digit (e.g., a thumb) on a user's hand. In the illustrated construction, in order to actuate the wrench 20, two control buttons 36 need to be contacted by the operator. Because each button 36 is operated by a user's thumb, each of the operator's hands will be on an adjacent handle 34, clear of any pinch points.

The buttons 36 of the illustrated embodiment are electrically coupled to the pump via wiring (not shown). Wires from the buttons extend through the body 12 to an electrical connection port 38 in the side of body 12. This connection port can be a mounted control cable quick connect. An external wire (not shown) can be connected to the connection port 38 to communicate with the pump. In other embodiments (not shown), wireless communication techniques can also be used.

As shown in FIGS. 3-5, an additional handle 40 is connected to the body 12 of the control assembly 11. This handle 40 extends in a direction that is generally perpendicular to the axis of rotation of the socket 24. This handle 40 can be used to lift and maneuver the wrench 20 without the need to contact the wrench 20 itself, which may eliminate the opportunity for pinch points between the wrench 20 and the items being fastened.

In operation, the wrench and control assembly 10 can be positioned such that the socket 24 is engaged with a nut to be tightened (or loosened). With respect to the illustrated embodiment of FIGS. 1 and 2, the operator can manipulate the wrench 20 into position with at least one hand on the positioning handle 40 and the other hand on the body 12 or control handles 34. Once the socket 24 is positioned on a nut, the operator grips each of the handles 34 and, in this position, can then manipulate the buttons 36 to turn and actuate the pump. This will cause the wrench 20 to turn the nut with the wrench 20 reacting off the reaction surface.

In a preferred method of operation, the operator will need to actuate two buttons 36 at the same time—one with each hand—in order for the pump to provide fluid to the wrench 20. Again, this feature ensures that the operator's hands on the handles 34 and free of pinch points prior to operation of the wrench 20 and the pump. This mode of operation is effective with the control assembly 11 attached to the wrench 20 or detached from the wrench 20 due to space constraints of the fastening location.

Once the actuation cycle is complete, the operator can release the actuation button 36 and actuate the “off” button to turn the pump off. The operator then can grasp the positioning handle 40 to lift the wrench 20 off of the nut being operated on and move the wrench to an adjacent nut. The process above then can be repeated.

Although the invention has be described in detail with reference to certain preferred embodiments, variations and modifications exist within the scope and spirit of one or more independent aspects of the invention as described above. For example, the illustrated embodiment utilizes two button control to ensure both hands are free of pinch points. In other embodiments, one or more sensors (e.g., capacitive touch sensors, dead man's switches, etc.) can be incorporated into each handle to ensure both hands are free from pinch points prior to actuation of the wrench.

One or more independent features and independent advantages of the invention may be set forth in the claims.

What is claimed is:

1. A control assembly for a fluid-operated, reciprocating piston-style torque wrench, the wrench including a housing, and a reciprocating drive mechanism supported by the housing, the drive mechanism being selectively-driven by a fluid pump and operable to drive an output member, the assembly comprising:
a body connectable to the housing;
a first handle and a second handle connected to the body;
a first sensor operable to sense an operator's first hand on the first handle; and
a second sensor operable to sense the operator's second hand on the second handle;
wherein operation of the pump requires sensing the operator's first hand on the first handle while sensing the operator's second hand on the second handle.

2. The assembly of claim 1, further comprising pump controls operable to control the pump to drive the drive mechanism and thereby the output member, the pump controls including the first sensor and the second sensor.

3. The assembly of claim 2, wherein the pump controls include
a first pump control supported proximate the first handle, the first pump control being operable by a digit of a first hand of an operator gripping the first handle, the first pump control acting as the first sensor, and
a second pump control supported proximate the second handle, the second pump control being operable by a digit of a second hand of the operator on the second handle, the second pump control acting as the second sensor,
wherein operation of the pump requires simultaneous operation of the first pump control and the second pump control.

4. The assembly of claim 3, wherein the pump controls include an on/off control operable to selectively turn the pump on and off.

5. The assembly of claim 3, wherein the pump controls further include an electrical connector operable to communicate between the pump and the first pump control and the second pump control.

6. The assembly of claim 1, wherein the body has a first end connectable to the housing and an opposite second end, the first handle and the second handle being supported on the second end.

7. The assembly of claim 1, further comprising a connecting device operable to releasably connect the body to the housing.

8. The assembly of claim 7, wherein the connecting device includes
a mounting bracket connectable between the body and the housing, and
a fastener operable to selectively connect the bracket to one of the body and the housing.

9. A torque wrench comprising:
a housing;
a reciprocating drive mechanism supported by the housing, the drive mechanism being selectively-driven by a fluid pump and operable to drive an output member; and
a control assembly including
a body connected to the housing,
a first handle and a second handle connected to the body, and
pump controls operable to control the pump to drive the drive mechanism and thereby the output member, the pump controls including
a first pump control supported proximate the first handle, the first pump control being operable by a digit of a first hand of an operator gripping the first handle, and
a second pump control supported proximate the second handle, the second pump control being operable by a digit of a second hand of the operator on the second handle,
wherein the pump is operable upon operation of the first pump control and the second pump control.

10. The wrench of claim 9, wherein the body is removably connected to the housing.

11. The wrench of claim 10, further comprising a connecting device operable to releasably connect the body to the housing.

12. The wrench of claim 11, wherein the connecting device includes
a mounting bracket connectable between the body and the housing, and
a fastener operable to selectively connect the bracket to one of the body and the housing.

13. The wrench of claim 9, wherein the pump controls include an on/off control operable to selectively turn the pump on and off.

14. The wrench of claim 9, wherein the pump controls further include an electrical connector operable to communicate between the pump and the first pump control and the second pump control.

15. The wrench of claim 9, wherein the body has a first end connected to the housing and an opposite second end, the first handle and the second handle being supported on the second end.

16. A method of operating a fluid-operated, reciprocating piston-style torque wrench, the wrench including a housing, and a reciprocating drive mechanism supported by the housing and operable to drive an output member, the method comprising:
providing a control assembly connected to the housing, the control assembly including a body connected to the housing and a first handle and a second handle connected to the body;
positioning the output member relative to a fastener to be adjusted; and
after positioning, operating a fluid pump to drive the drive mechanism and thereby the output member to adjust the fastener, operating including sensing the operator's first hand on the first handle while sensing the operator's second hand on the second handle.

17. The method of claim 16, wherein the control assembly includes pump controls operable to control the pump, the pump controls including a first pump control supported proximate the first handle, the first pump control being operable by a digit of a first hand of an operator gripping the first handle, the first pump control acting as the first sensor, and a second pump control supported proximate the second handle, the second pump control being operable by a digit of a second hand of the operator on the second handle, the second pump control acting as the second sensor, and wherein operating simultaneously operating the first pump control and the second pump control.

18. The method of claim 16, further comprising releasably connecting the body to the housing.

19. The method of claim 18, wherein the body has a first end and an opposite second end, and wherein releasably connecting includes releasably connecting the first end to the housing, the first handle and the second handle being supported on the second end.

20. The method of claim 16, wherein operating includes operating the pump with the control assembly disconnected from the housing.
